(19) United States
(12) Patent Application Publication
(10) Pub. No.: US 2016/0149248 A1
(43) Pub. Date: May 26, 2016

(54) METHOD FOR PERFORMANCE RESTORATION OF FUEL CELL

(71) Applicant: HYUNDAI MOTOR COMPANY, Seoul (KR)

(72) Inventors: Dong Jo OH, Yongin-si (KR); Jong Hyun LEE, Yongin-si (KR)

(21) Appl. No.: 14/925,890

(22) Filed: Oct. 28, 2015

(30) Foreign Application Priority Data
Nov. 25, 2014 (KR) 10-2014-0164911

(51) Int. Cl. H01M 8/06

(52) U.S. Cl. CPC H01M 8/0693; H01M 8/0668

(57) ABSTRACT

A method for performance restoration of a fuel cell includes shutting off a supply of hydrogen to an anode to arbitrarily and unevenly drop a cell voltage of the fuel cell when air is supplied to a cathode together with start-off of the fuel cell. A reverse voltage occurs in some cells of the fuel cells, a water-splitting reaction occurs at the anode of the cell in which the reverse voltage occurs, and oxygen generated by the water-splitting reaction removes carbon monoxide (CO), which has contaminated the anode, by oxidizing the carbon monoxide (CO) to carbon dioxide (CO₂).

### CROSS-REFERENCE TO RELATED APPLICATION

This application claims under 35 U.S.C. §119(a) the benefit of Korean Patent Application No. 10-2014-0164911 filed on Nov. 25, 2014, the entire contents of which are incorporated herein by reference.

### TECHNICAL FIELD

The present disclosure relates to a method for performance restoration of a fuel cell. More particularly, it relates to a method for performance restoration of a fuel cell that is configured to be able to remove carbon monoxide or the like by oxidation using a reverse voltage operation so as to prevent performance degradation of the fuel cell, when the fuel cell is poisoned by impurities such as carbon monoxide (CO).

### BACKGROUND

A fuel cell as a main power supply source of a fuel cell vehicle is a device which generates electricity by receiving supply of oxygen in the air and hydrogen as fuel.

A membrane-electrode assembly (MEA) is a main constituent of a fuel cell located on the innermost side of the fuel cell. The membrane-electrode assembly is constituted by an electrolyte membrane capable of moving hydrogen proton, and a catalyst layer applied to both sides of the electrolyte membrane to allow a reaction of hydrogen and oxygen, that is, a cathode and an anode.

Further, a gas diffusion layer (GDL) and a bipolar plate are located in an outer portion of the membrane-electrode assembly (MEA), that is, in the outer portion in which the catalyst layer is located. The bipolar plate is formed with a flow field so as to supply fuel to the outer portion of the gas diffusion layer and discharge water generated by the reaction.

Therefore, in the anode of the fuel cell, the oxidation reaction of hydrogen progresses to generate hydrogen ions and electrons. The generated hydrogen ions and the electrons are moved to the cathode through the electrolyte membrane and wiring, respectively.

At the same time, as shown in accompanying FIG. 1, in the cathode of the fuel, water is generated, while the reduction reaction of oxygen progresses by receiving the hydrogen ions and electrons from the anode. Thus, the electrical energy is generated by the flow of electrons along the wiring, and the electrical energy is generated by the flow of protons through the polymer electrolyte membrane.

Meanwhile, hydrogen supplied to the anode contains impurities such as carbon monoxide, sulfur, carbon dioxide and ammonia. In particular, when the hydrogen gas containing carbon monoxide as a polymer electrolyte fuel cell, the anode catalyst is poisoned by carbon monoxide (CO), and the performance of the fuel cell is significantly deteriorated.

More specifically, a platinum (Pt) catalyst is used so that the oxidation-reduction reaction occurs in each of the anode and the cathode of the fuel cell. When carbon monoxide and hydrogen enter the anode as an oxidation electrode, carbon monoxide is adsorbed on the platinum surface to interfere with the oxidation reaction in the anode, and consequently, a performance reduction phenomenon in which the output of the fuel cell is lowered occurs.

Therefore, in order to recover the performance of the fuel cell, it is necessary to remove carbon monoxide in a suitable way when poisoned by carbon monoxide as described above.

As a way to solve the poisoning problems of the conventional fuel cell, when the anode is poisoned by carbon monoxide (CO) or the like and performance degradation of the fuel cell occurs, a technique of supplying a small amount of air to the anode to remove carbon monoxide by oxidation has been widely known.

However, as an external device for supplying oxygen to the fuel cell, since there is an additional need for oxygen supply equipment including an oxygen tank, a control device for the oxygen supply, a valve or the like, there has been a problem of a rise in cost for the performance restoration operation of the fuel cell vehicle.

Further, since the fuel cell vehicle needs to travel to a facility to obtain separate oxygen supply equipment, there is a problem in delaying performing the restoration operation.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present disclosure have been made to solve the conventional problems as described above, and an object thereof is to provide a method for performance restoration of a fuel cell in which, by shutting off a supply of hydrogen to an anode to arbitrarily and unevenly lower the cell voltage of the fuel cell in a state where the air is supplied to a cathode together with start-off of the fuel cell, a reverse voltage occurs in some cells of the fuel cells, a water-splitting reaction occurs at the anode of the cell in which the reverse voltage occurs, and oxygen generated by the water-splitting reaction removes carbon monoxide (CO) which contaminates the anode by oxidizing the carbon monoxide to carbon dioxide (CO₂).

In one aspect, the present disclosure provides a method for performance restoration of fuel cell including: (i) arbitrarily and unevenly lowering the cell voltage of the fuel cell; (ii) generating a reverse voltage in some cells of the fuel cells by the uneven drop of the cell voltage of the fuel cell; (iii) generating a water-splitting reaction at an anode of the some cells in which the reverse voltage occurs so as to generate oxygen; and (iv) removing carbon monoxide (CO), which contaminates the anode, by oxidizing the carbon monoxide with the generated oxygen to carbon dioxide (CO₂).

In a preferred embodiment, at the step (i), the cell voltage of the fuel cell is arbitrarily and unevenly lowered by shutting off a hydrogen supply and a hydrogen recycle supply to the anode when air is supplied to the cathode together with start-off of the fuel cell.

In another preferred embodiment, at the step (ii), the voltage of the some cells in which the reverse voltage occurs is lowered to 0V or less.

In still another preferred embodiment, after maintaining arbitrarily and unevenly lowering the fuel cell voltage for a predetermined time, in order to manage the voltage of the fuel cell when restarting by the open circuit voltage, air to the cathode is blocked, and at the same time, the hydrogen recycle supply to the anode is performed.

Through the means for solving the above-mentioned problems, the present invention provides the following effects.

First, the reverse voltage is generated in the some cells of the fuel cells, the water-splitting reaction occurs in the anode of the cell in which the reverse voltage occurs, and oxygen generated by the water-splitting reaction can remove carbon monoxide (CO), which has contaminated the anode, by oxidizing the carbon monoxide with the generated oxygen to carbon dioxide (CO₂). Thus, the performance restoration of the fuel cell can be performed.

Second, when the performance is degraded due to contamination of the anode, the performance restoration of the fuel cell can be performed without disengagement of the entire system or an external device for the air supply.

Other aspects and preferred embodiments of the invention are discussed infra.

It is understood that the term “vehicle” or “vehicular” or other similar term as used herein is inclusive of motor vehicles in general such as passenger automobiles including sports utility vehicles SUV, buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles e.g. fuels derived from resources other than petroleum. As referred to herein, a hybrid vehicle is a vehicle that has two or more sources of power, for example both gasoline-powered and electric-powered vehicles.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram showing a reaction of an anode and a cathode of a fuel cell during normal operation of the fuel cell;

FIG. 2 is a schematic diagram showing that a reverse voltage is generated in some of the entire fuel cells for the method for performance restoration of the fuel cell according to an embodiment of the present invention; and

FIG. 3 is a diagram showing a reaction of an anode and a cathode of a fuel cell for a method for performance restoration of a fuel cell according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, a preferred embodiment of the present invention will be described in detail with reference to the accompanying drawings.

As described above, hydrogen supplied to the anode of the fuel cell contains impurities, such as carbon monoxide, sulfur and carbon dioxide, depending on the used fuel. When the hydrogen gas containing carbon monoxide is used as a polymer electrolyte fuel cell, the anode catalyst is poisoned by carbon monoxide (CO), and the performance of the fuel cell may be greatly deteriorated.

Thus, when the anode of the fuel cell is poisoned by impurities such as carbon monoxide (CO), it may lead to performance degradation of the fuel cell, the present invention is based on that, after induction of an water-splitting reaction at the anode using a reverse voltage operation, carbon monoxide can be removed by oxygen produced during the water-splitting reaction by oxidation.

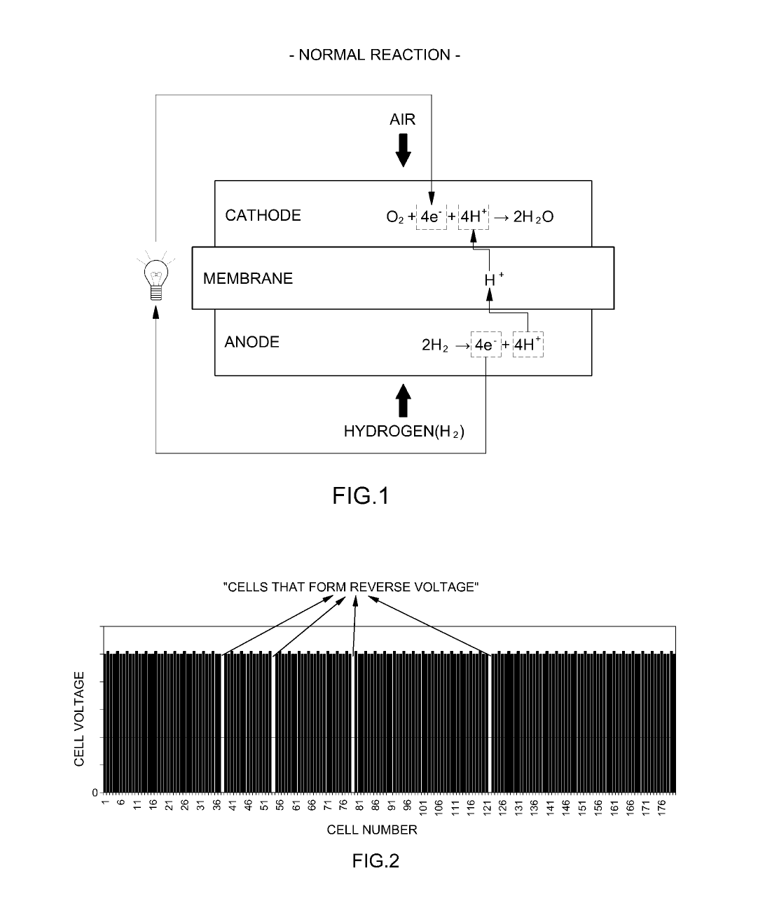

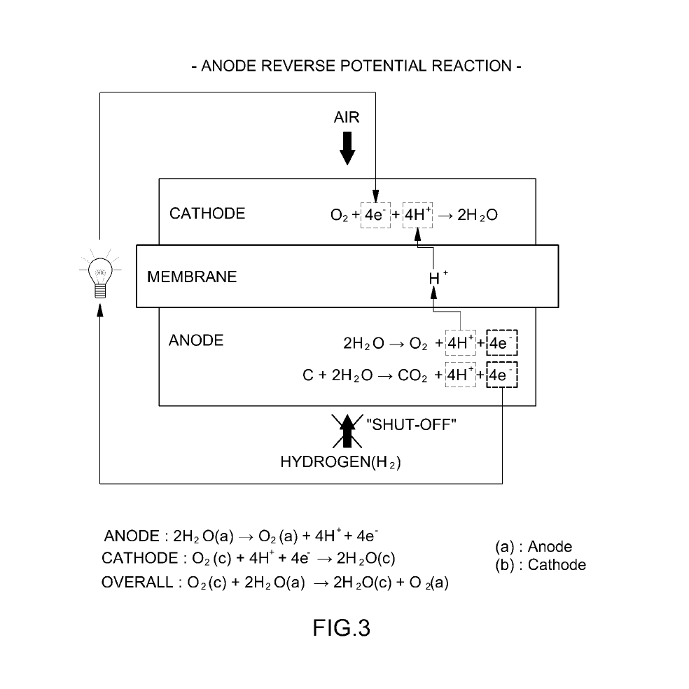

FIG. 2 is a schematic diagram showing that a reverse voltage is generated in some of the entire fuel cells for a method for performance restoration of a fuel cell according to an embodiment of the present invention, and FIG. 3 is a diagram showing a reaction of an anode and a cathode for a method for performance restoration of a fuel cell according to an embodiment of the present invention.

A unit fuel cell generates a maximum voltage, for example, 1V, which is insufficient to drive a motor. Therefore, in order to drive a motor that requires a voltage much higher than the maximum voltage provided by a unit fuel cell, typically dozens of to several hundred unit fuel cells are stacked to form a fuel cell stack. When a large number of unit fuel cells are stacked to form a fuel cell stack, the distribution of the fluid is generally non-uniform; therefore, in order to provide the uniform distribution, a blower, an ejector or the like is used.

At this time, when shutting off a hydrogen supply and a hydrogen recycle supply to the anode in a state in which air is supplied to the cathode with the start-off of the fuel cell stack, hydrogen of some cells of the fuel cell stack is depleted earlier than other cells, the cell voltage of the fuel cell in which hydrogen is depleted first drops, and thus, the cell voltage of the fuel cell stack becomes a non-uniform state.

At this time, when the cell voltage of some cells of the fuel cell stack unevenly drops, the reverse voltage phenomenon occurs.

That is, since the respective cells of the fuel cell stack are connected in series, the same current should flow through the low-voltage cells (i.e., the cells of which the cell voltage drops) as in the high-voltage cells (i.e., the other cells of which the cell voltage maintains at the maximum voltage), and at this time, the reverse voltage phenomenon in which the potential of the anode increases.

That is to say, since the anode voltage is hydrogen standard potential, the voltage is already 0V in the state of normally supplying hydrogen, and the reverse voltage refers to a phenomenon in which the potential of the anode rises to 0V or more and becomes higher than the cathode.

More specifically, as the cell voltage of the fuel cell unevenly drops, the reverse voltage is generated in some cells of the fuel cell stack, and the voltage of some cells in which the reverse voltage is generated at this time drops to 0V or less.

In other words, the reverse voltage phenomenon occurs in which the potential of the anode becomes higher while the voltage of some cells of the fuel cell stack drops to 0V.

On the other hand, during normal operation of the fuel cell, as shown in Reaction Formula 1 below, water is generated in the cathode of the fuel cell, while the reduction reaction of oxygen progresses by receiving the hydrogen ions and electrons from the anode, and at this time, the water also partially remains in the anode through the polymer electrolyte membrane.

Cathode: O₂+4H+⁺4e⁻→2H₂O (1)

Therefore, the water-splitting reaction occurs at the anode of some cells in which the reverse voltage occurs.

In other words, the water-splitting reaction occurs in the anode by the reverse voltage phenomenon described above.

At this time, water remains by partially passing across from the cathode to the anode. Since there is no potential at the cell that does not involve the reaction to produce electricity, that is, at the cell in which the voltage of the anode drops to 0V, in the anode, the water-splitting phenomenon occurs in which water is decomposed into oxygen and hydrogen ions as in Reaction Formula 2.

Anode: 2H₂O→O₂+4H⁺+4e⁻ (2)

Preferably, before the step of occurrence of the above-described water-splitting reaction, a step of allowing the cooling water to circulate using a radiator and a water pump included in the fuel cell system to cool the fuel cell to a room temperature is further performed to promote the water-splitting, by cooling water vapor in the fuel cell to an ambient temperature changed into water.

Subsequently, oxygen produced by the water-splitting reaction as described above removes carbon monoxide (CO), which has contaminated the anode, by oxidizing the carbon monoxide (CO) to carbon dioxide (CO₂).

In this way, the reverse voltage is generated at some cells of the fuel cells, the water-splitting reaction occurs in the anode of the cell in which the reverse voltage is generated, and oxygen generated by the water-splitting reaction can remove carbon monoxide (CO), which has contaminated the anode, by oxidizing the carbon monoxide to carbon dioxide (CO₂). Thus, it is possible to perform the performance restoration of the fuel cell without an existing separate external device for air supply.

Meanwhile, after the time of unevenly lowering the cell voltage of the fuel cell is maintained for several seconds, the fuel cell is activated in a normal way using a battery.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for performance restoration of a fuel cell, the method comprising steps of:
(i) arbitrarily and unevenly dropping a cell voltage of fuel cells;
(ii) generating a reverse voltage in some of the fuel cells by arbitrarily and uneven dropping the cell voltage of the fuel cells;
(iii) generating a water-splitting reaction at an anode of the some of the fuel cells in which the reverse voltage occurs so as to generate oxygen; and
(iv) removing carbon monoxide (CO), which contaminates an anode, by oxidizing the carbon monoxide (CO) with the generated oxygen to carbon dioxide (CO₂).

2. The method of claim 1, wherein at the step (i), the cell voltage of the fuel cells is arbitrarily and unevenly dropped by shutting off a hydrogen supply and a hydrogen recycle supply to the anode when air is supplied to the cathode together with the start-off of the fuel cells.

3. The method of claim 1, wherein at the step (ii), the voltage of the some of the fuel cells in which the reverse voltage occurs is lowered to 0V or less.

4. The method of claim 1, further comprising a step of:
after maintaining arbitrarily and unevenly lowering the fuel cell voltage for a predetermined time, blocking air to the cathode, and simultaneously performing a hydrogen recycle supply to the anode in order to manage the voltage of the fuel cells when restarting by an open circuit voltage.

5. The method of claim 1, further comprising a step of cooling the fuel cell to a room temperature prior to the step (iii) of generating the water-splitting reaction.
